(19) United States
(12) Patent Application Publication
(10) Pub. No.: US 2006/0119958 A1
(43) Pub. Date: Jun. 8, 2006

(54) Optical system for high resolution using plastic lenses

(75) Inventor: Jae Cheol Jeong, Suwon (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Samsung Electro-Mechanics Co., Ltd., Suwon (KR)

(21) Appl. No.: 11/126,276

(22) Filed: May 11, 2005

(30) Foreign Application Priority Data
Dec. 3, 2004 (KR) 10-2004-100877

(51) Int. Cl. G02B 9/14

(52) U.S. Cl. 359/785

(57) ABSTRACT

An optical system of a high resolution using only plastic lenses is provided. The system includes, sequentially from an object side: an aperture stop; a plastic first lens; a plastic second lens; a plastic third lens. The first plastic lens has plus refractive power. The second plastic lens has minus refractive power. The third plastic lens has plus refractive power. A refractive index and an abbe number of the second lens satisfy equations of 1.59<n2<1.65, 20<v2<30 (where, n2: refractive index of the second lens, v2: abbe number of the second lens). The optical system can realize an optical system of a high resolution having a small size and a light weight using only plastic lenses.

### RELATED APPLICATION

The present application is based on, and claims priority from, Korean Application Number 2004-0100877, filed Dec. 3, 2004, the disclosure of which is hereby incorporated by reference herein in its entirety.

### BACKGROUND OF THE INVENTION

1. Field of the Invention

The present invention relates to an optical system for a high resolution using plastic lenses, and more particularly, to an optical system for a high resolution capable of obtaining a high resolution with a small size and a light weight using three plastic lenses having plus, minus, and plus refractive power, respectively.

2. Description of the Related Art

Generally, a mobile phone has only a communication function at its early stage. As the mobile phone is widely used, provided service is extended to taking a photograph, an image transmission and communication. Accordingly, related functions and services are developing rapidly. Recently, an extended, new concept mobile phone combining a digital camera technology and a mobile phone technology, namely, a so-called camera phone or camera mobile phone is drawing attention. Further, there has been made an attempt to develop a so-called camcorder mobile phone or camcorder phone that can store and transmit moving images multimedia data having a capacity of more than several ten minutes by combining a digital camcorder technology with the mobile phone technology.

As not only the mobile phone but also a personal computer (PC) is widely distributed, the PC camera for image chatting and video conference is widely distributed rapidly and used widely among general public. Also, a general still camera is rapidly replaced by a digital camera.

Such cameras require generally small-sized and light-weight camera units in viewpoint of its characteristics. For that purpose, a related art mobile phone camera uses a plastic aspherical lens consisting of two lenses for three hundred thousand-pixel class. However, such a lens is not appropriate for ambient light and cannot obtain a desired resolution, thus the camera mounting the above lens cannot be applied to a mobile phone of a high resolution.

In the meantime, since a high image quality is required for a digital camera compared with a mobile phone, a charged coupled device (CCD) having a relatively large number of pixels is used for the digital camera and also a lens having a structure similar to a video tape recorder (VTR) is adopted by the digital camera so as to support a high image quality.

Since such a lens requires even higher quality in viewpoint of a resolution and an image quality required, a lens system having a large number of lens combination has been used, which has increased manufacturing costs. Further, a large number of lenses are used for such a lens system and the lenses are manufactured with a glass, thus the lens system becomes large in its volume and heavy in its weight, which has become a hindrance to a small-sizing and a light-weight.

Therefore, an optical system capable of realizing a high resolution in a small size and a light-weight is required.

### SUMMARY OF THE INVENTION

Accordingly, the present invention is directed to an optical system for a high resolution using plastic lenses that substantially obviates one or more problems due to limitations and disadvantages of the related art.

An object of the present invention is to provide an optical system for a high resolution using compact, plastic lenses such that only three-plastic-lens combination is used to achieve a high resolution with a small number of lens combination.

Another object of the present invention is to provide an optical system for a high resolution using plastic lenses capable of being applied to a mass production thanks to its easy manufacturing and reducing manufacturing costs as well as achieving light weight.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an optical system for a high resolution using plastic lenses, which includes, sequentially from an object side: an aperture stop arranged most closely to the object side; a first plastic lens having plus refractive power; a second plastic lens having minus refractive power; and a third plastic lens having plus refractive power, a refractive index of the second lens satisfying the following equation 1, and an abbe number of the second lens satisfying the following equation 2:
1.59<n2<1.65 Equation 1,
20<v2<30 Equation 2,

where, n2: refractive index of second lens

v2: abbe number of second lens.

The optical system for the high resolution may additionally satisfy the following equations 3 through 6 for refractive indexes of the first and the third lenses and abbe numbers of the first and the third lenses:
1.45<n1<1.59 Equation 3,
50<v1<60 Equation 4,
1.45<n3<1.59 Equation 5,
50<v3<60 Equation 6,

where, n1: refractive index of first lens

v1: abbe number of first lens

n3: refractive index of third lens

v3: abbe number of third lens

The optical system for the high resolution may additionally satisfy the following equation 7 for a power of the first lens and satisfy the following equation 8 for a measure in an optical axis direction of the entire lens system:
0.5<f1/f<1.0 Equation 7,
TL/f<2.0 Equation 8,

where, f1: focal length of first lens

f: focal length of entire optical system

TL: distance from aperture stop to image plane

Further, the optical system for the high resolution may additionally satisfy the following equation 9 for powers of the first and the second lenses:
0.5<|f2|/f1<2.0 Equation 9

where, f2: focal length of second lens (f2<0)

At least one refraction plane among refraction planes of the first, the second, and the third lenses may be an aspherical plane.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a lens construction of an optical system for a high resolution according to the present invention;

FIG. 2 is a graph explaining aberrations of the first embodiment shown in FIG. 1, in which (a), (b), and (c) represent a spherical aberration, astigmatism, and distortion, respectively;

FIG. 3 is a graph illustrating MTF characteristics of the first embodiment shown in FIG. 1;

FIG. 4 is a view illustrating a lens construction of an optical system for a high resolution according to a second embodiment of the present invention;

FIG. 5 is a graph explaining aberrations of the second embodiment shown in FIG. 4, in which (a), (b), and (c) represent a spherical aberration, astigmatism, and distortion, respectively;

FIG. 6 is a graph illustrating MTF characteristics of the second embodiment shown in FIG. 4;

FIG. 7 is a view illustrating a lens construction of an optical system for a high resolution according to a third embodiment of the present invention;

FIG. 8 is a graph explaining aberrations of the third embodiment shown in FIG. 7, in which (a), (b), and (c) represent a spherical aberration, astigmatism, and distortion, respectively; and

FIG. 9 is a graph illustrating MTF characteristics of the third embodiment shown in FIG. 7.

### DETAILED DESCRIPTION OF THE INVENTION

Reference will now be made in detail to the preferred embodiments of the present invention, examples of which are illustrated in the accompanying drawings.

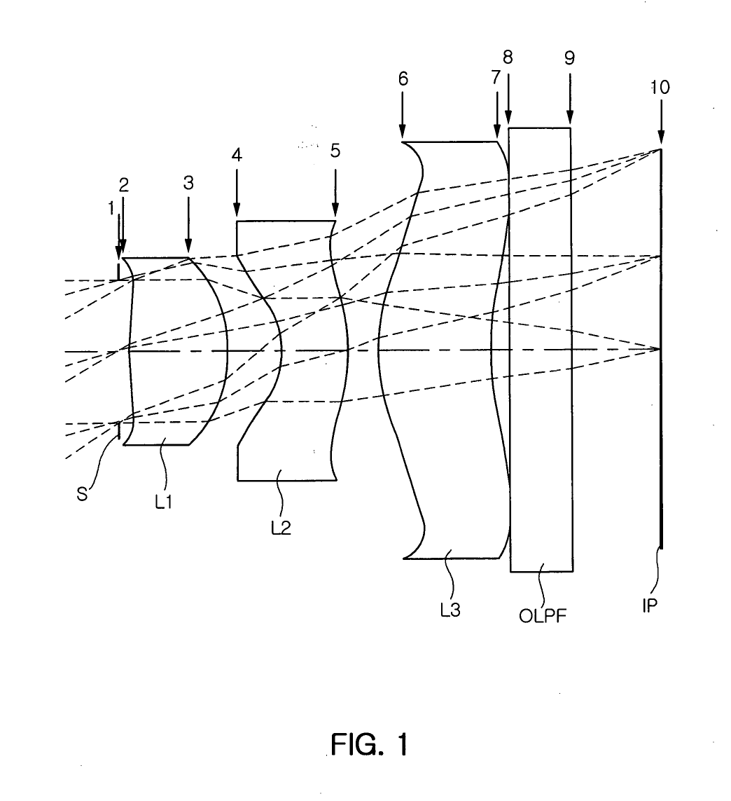

FIG. 1 is a view illustrating a lens construction of an optical system for a high resolution using plastic lenses according to a first embodiment of the present invention. In the following views illustrating a lens construction, a thickness, a size, and a shape of a lens have been exaggerated more or less for explanation. Particularly, shapes of the spherical and the aspherical surfaces illustrated in the drawings have been suggested for an example purpose only and not limited to those shapes.

Referring to FIG. 1, an optical system for a high resolution using plastic lenses according to an embodiment of the present invention includes, sequentially from an object side: an aperture stop S arranged most closely to the object side for removing unnecessary light; a first plastic lens L1 of plus refractive power; a second plastic lens L2 having minus refractive power; a third plastic lens L3 having plus refractive power; and an optical filter (OLPF) consisting of an ultraviolet (uv) filter, and a glass provided between the third lens L3 and an image plane (IP).

Here, it is possible to minimize an influence of defocus amount which a curvature variation within the first lens L1 might have over the entire field by arranging the aperture S of the optical system in front of the first lens L1 which is a curvature varied portion.

In the meantime, an optical system requires a telecentricity in which chief rays incident to an image plane become parallel with respect to an optical axis. The present invention may arrange the aperture S distant away from the image plane as much as possible in order to satisfy the telecentricity.

That is, the present invention arranges the aperture S most closely at an object side to reduce an incident angle at which the chief rays are incident to the image plane, thereby conforming to the telecentricity requirement.

The first lens L1 is made of plastics and has plus refractive power and the second lens L2 has minus refractive power whose size is similar to a size of refractive power of the first lens L1. Aberration is corrected by interaction between the first and the second lenses L1 and L2.

Further, the third lens L3 has a weak plus refractive power so that the first lens L1 may be made small in its power to correct off-axis aberration. The third lens L3 may be formed in a seagull shape having two inflection points.

The present invention corrects a chromatic aberration of an optical system by adopting the first lens L1 having a small refractive index and a large abbe number and the second lens L2 having a large refractive index and a small abbe number and by making refractive powers of the first and the second lens L1 and L2 similar each other.

In the meantime, at least one refraction plane of refraction planes of the first, the second, and the third lenses L1, L2, and L3 may be an aspherical plane in order to reduce an aberration generated due to the fact that the refraction planes are spherical.

With the above-described entire construction, the following equations 1 to 9 will be examined hereinafter.
1.59<n2<1.65 Equation 1,
20<v2<30 Equation 2,
1.45<n1<1.59 Equation 3,
50<v1<60 Equation 4,
1.45<n3<1.59 Equation 5,
50<v3<60 Equation 6

where, n1: refractive index of first lens

v1: abbe number of first lens

n2: refractive index of second lens

v2: abbe number of second lens

n3: refractive index of third lens

v3: abbe number of third lens

The equations 1, 3, and 5 describe conditions for refractive indexes of the second, the first, and the third lenses L2, L1, and L3, respectively. A refractive index of the second lens L2 is larger than those of the first and the third lenses L1 and L3.

Further, the equations 2, 4, and 6 describe conditions for abbe numbers of the second, the first, and the third lenses L2, L1, and L3. An abbe number of the second lens L2 is smaller than those of the first and the third lenses L1 and L3.

Generally, when an abbe number becomes small in case of a single lens, a dispersion value becomes large thus a chromatic aberration is difficult to correct. On the contrary, when an abbe number becomes large, a dispersion value becomes small and variations in a refractive index becomes small thus a chromatic aberration becomes advantageously small.

Therefore, since a chromatic aberration is difficult to correct in case only the second lens L2 satisfying the equations 1 and 2 is used, the present invention corrects a chromatic aberration through combination of the second lens L2 with the first lens L1 whose refractive index is smaller than the refractive index of the second lens L2 and whose abbe number is relatively bigger than the abbe number of the second lens L2.

That is, in a related art optical system, interaction between a crown-series lens having a relatively big abbe number and a relatively small refractive index and a flint-series lens having a small abbe number and a large refractive index has been used to correct a chromatic aberration of a light beam. In this context, the optical system of the high resolution according to the present invention corrects a chromatic aberration using the first lens L1 having a small refractive index and a large abbe number and the second lens L2 having a large refractive index and a small abbe number.

The first lens L1 will do as far as the first lens L1 is smaller in its refractive index and relatively greater in its abbe number than the second lens L2. More desirably, the first lens L1 may be formed with general plastic optical material satisfying the equations 3 and 4 regarding the refractive index and the abbe number as described below.

At this point, if the first and the second lenses L1 and L2 are greatly different in their refractive power size, a chromatic aberration is difficult to correct due to the difference in their refractive power, thus the refractive powers of the first and the second lenses L1 and L2 may be similar in their size as described in the equation 9 below.

In the related art, an E48R of a ZEONEX series whose refractive index for a d-line wavelength (primary wavelength of a visible light: 587.6 nm) is about 1.531 and whose abbe number is about 55.87 has been mainly used for a plastic lens. However, merely with the plastic lens having the above refractive index and the abbe number, it is difficult to correct an aberration. Thus, the plastic lens and a glass lens should be combined and used. On the contrary, the present invention provides an advantage of realizing an optical system of a high resolution, a small size, and light weight by combining the plastic lenses satisfying the equations 1 and 2 with the related art plastic lens.

For one example of optical material made of plastics for use in the second lens L2 that satisfies the equations 1 and 2, OKP4 by Osaka Gas Chemical Co., Ltd. such that a refractive index for the d-line wavelength is 1.613 and an abbe number is 26.65, can be used.

In the meantime, the third lens L3 may be made of plastics such that its refractive index is smaller and its abbe number is greater than the second lens L2 so as to reduce an aberration of light that has passed through the first and the second lenses L1 and L2.

As described above, the present invention has advantages of realizing a small-sized and slim-profile optical system and providing an optical system of light weight that can be easily manufactured through mass production process with low manufacturing costs compared with the related art optical system by removing a chromatic aberration using plastic lenses having different refractive indexes and different abbe numbers.
0.5<f1/f<1.0 Equation 7,
TL/f<2.0 Equation 8

where, f1: focal length of first lens

f: focal length of entire optical system

TL: distance from aperture stop to image plane

The equation 7 prescribes a power of the first lens L1. If f1 becomes large beyond an upper limit of the equation 7, the powers of the second and the third lenses L2 and L3 constructed by a single lens should increase, which causes a problem that a chromatic aberration is increased. On the contrary, if f1 becomes small below a lower limit of the equation 7, the power of the first lens L1 becomes excessively large so that a spherical aberration and a comatic aberration become large. Further, a curvature radius of a spherical surface of a lens constituting the first lens. L1 becomes small, which makes processing the lens difficult.

The equation 8 is a small-sizing condition for prescribing a total length (TL) of a lens. If a TL exceeds an upper limit of the equation 8, it is advantageous in correcting aberrations in a high image quality but contradictory in a viewpoint of a subminiature feature, which is one characteristics of the present invention.
0.5<|f2|/f1<2.0 Equation 9

where, f2: focal length of second lens (f2<0)

The first lens L1 has plus refractive power and the second lens L2 has minus refractive power, thus if |f2|/f1 exceeds an upper limit or go beyond a lower limit of the equation 9 and a difference in absolute values of the refractive powers of the first and the second lenses L1 and L2 becomes too large, canceling aberrations using the first and the second lenses L1 and L2 gets difficult, so that aberrations cannot be corrected by the third lens L3.

For example, since the first lens L1 has a big abbe number, its dispersion value is small so that a small chromatic aberration is generated. On the contrary, the second lens L2 has a small abbe number, its dispersion value is large so that a large chromatic aberration is generated. Accordingly, if a power of one lens is relatively too big, a canceling effect for aberrations by combination of the first and the second lens L1 and L2 is remarkably reduced and the chromatic aberration is generated much.

The present invention will be described in more detail according to a preferred embodiment in the following.

As described above, the following embodiments 1 to 3 all include, sequentially from an object side: an aperture stop S arranged most closely to the object side; a first plastic lens L1 of plus refractive power; a second plastic lens L2 having minus refractive power; a third plastic lens L3 having plus refractive power; and an optical filter (OLPF) consisting of an ultraviolet (uv) filter and a cover glass provided between the third lens L3 and an image plane (IP).

Aspherical surfaces used in each of the following embodiments and the following comparison examples are obtained by the following known formula 1. An E and a number following the E used in a conic constant K and aspherical coefficients A, B, C and D represent a 10's power. For example, E+21 and E−02 represent 10²¹ and 10⁻², respectively.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad Formula 1$$

where, Z: distance toward optical axis from vertex of lens

Y: distance toward direction perpendicular to optical axis

r: radius of curvature on vertex of lens

K: conic constant

A, B, C, D, E and F: aspherical coefficients

### FIRST EMBODIMENT

The following table 1 represents numerical examples according to a first embodiment of the present invention.

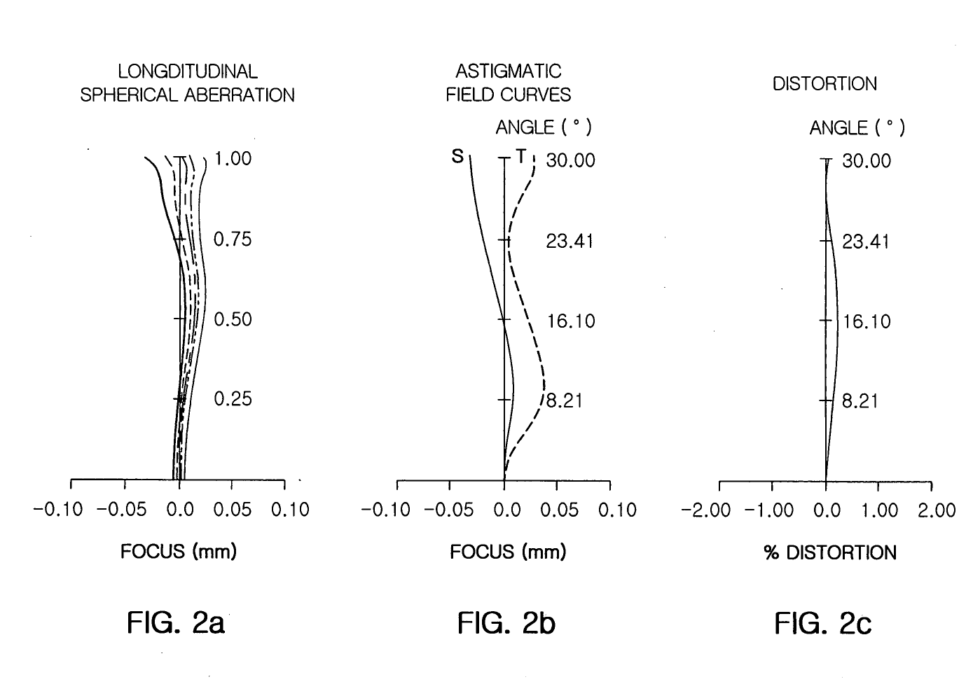

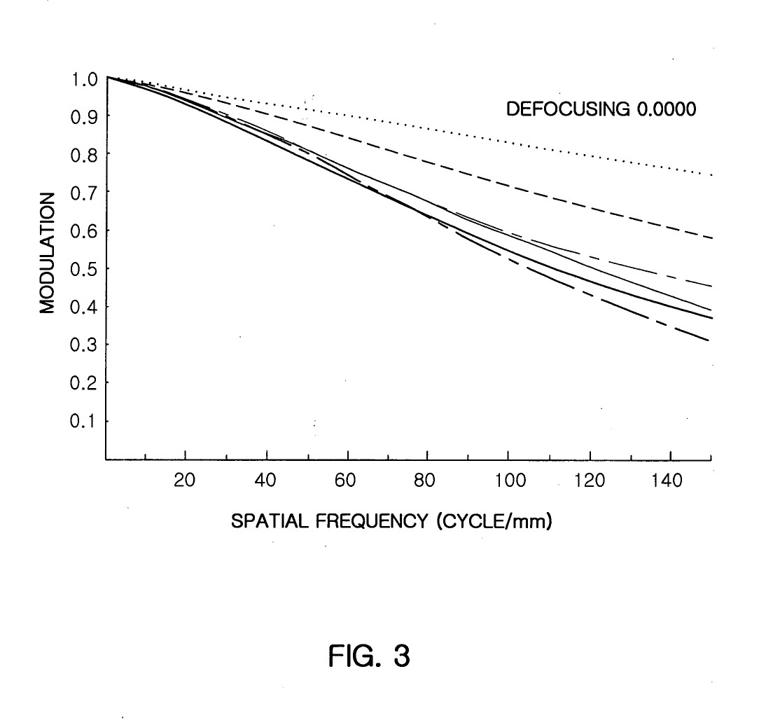

FIG. 1 is a view illustrating a lens construction of an optical system of a high resolution using plastic lenses according to the first embodiment of the present invention, FIGS. 2A through 2C are graphs explaining aberrations of the optical system shown in table 1 and FIG. 1, and FIG. 3 is a graph illustrating modulation transfer function (MTF) characteristics of the first embodiment.

A thickness, a size, and a shape of a lens have been exaggerated more or less in the following lens construction, and shapes of the spherical and the aspherical surfaces illustrated in the drawings have been suggested for an example purpose only and not limited to those shapes.

Further, in the following graph illustrating astigmatism, “S”, “T” represent sagital, tangential, respectively.

Here, the MTF depends on a spatial frequency of a cycle per millimeter and is defined by the following formula 2 between a maximum intensity and a minimum intensity of light.

$$MTF = \frac{Max - Min}{Max + Min} \qquad Formula 2$$

That is, if the MTF is 1, a resolution is most ideal and a resolution falls down as the MTF is reduced.

In the first embodiment, an F number (FNo.) is 2.46, an angle of view 68°, a distance from the aperture stop to an image plane (IP) of an optical system (referred to as “TL” hereinafter) is 4.9 mm, an entire focal length f is 3.2 mm, focal lengths f1, f2, and f3 of the first, the second, and the third lenses are 2.0 mm, −1.98 mm, 3.3 mm, respectively. The above lens system is appropriate for a 1/4.5 inch sensor of two-million pixel class.

Further, in the following embodiment, E48R of a ZEONEX series has been used for the first and the third lenses L1 and L3. OKP4 by the Osaka Gas Chemical Co., Ltd. has been used for the second lens L2.

As described in the following tables 1, 3, and 5, in case of the E48R, a refractive index for a d-line wavelength (primary wavelength of a visible light: 587.6 nm) is 1.531, an abbe number is 55.87. In case of the OKP4, a refractive index for the d-line wavelength is 1.613 and an abbe number is 26.65.

TABLE 1

| | Radius of | Plane | | Abbe | |
|---|---|---|---|---|---|
| Plane | curvature | interval | Refractive | number | |
| No. | (R) | (t) | index (N_{d}) | (v_{d}) | Remark |
| 1 | ∞ | 0.100000 | | | Aperture |
| | | | | | stop |
| *2 | 3.34615 | 0.880000 | 1.531 | 55.87 | 1st lens |
| *3 | −1.47825 | 0.490000 | | | |
| *4 | −0.69718 | 0.600000 | 1.613 | 26.65 | 2nd lens |
| *5 | −2.16773 | 0.290000 | | | |
| *6 | 1.24275 | 1.040000 | 1.531 | 55.87 | 3rd lens |
| *7 | 2.84458 | 0.168555 | | | |
| 8 | ∞ | 0.550000 | 1.519 | 64.2 | Optical |
| 9 | ∞ | 0.800000 | | | filter |
| 10 | ∞ | 0.000000 | | | Image |
| | | | | | plane |

In table 1, * represents an aspherical surface. In case of the first embodiment, a second plane (object side of the first lens), a third plane (image side of the first lens), a fourth plane (object side of the second lens), a fifth plane (image side of the second lens), and sixth plane (object side of the third lens), and a seventh plane (image side of the third lens) are aspherical.

Aspherical coefficients of the first embodiment by the formula 1 are given in the following tables 2A and 2B.

TABLE 2A

| | K | A | B | C |
|---|---|---|---|---|
| 2nd | 2.98851E−01 | 0.00000E+00 | −1.01059E−01 | −1.67953E−01 |
| plane | | | | |
| 3rd | −6.76476E−01 | 9.80953E−01 | −8.23019E−02 | 3.63139E−02 |
| plane | | | | |
| 4th | −1.43435E+00 | −5.58234E−01 | 2.82041E−01 | 4.29157E−01 |
| plane | | | | |
| 5th | −4.61312E−01 | 3.55830E−02 | −1.65353E−01 | 4.44829E−01 |
| plane | | | | |
| 6th | 8.04667E−01 | −5.95811E+00 | −4.89609E−02 | 4.66073E−02 |
| plane | | | | |
| 7th | 3.51546E−01 | −5.61899E−01 | −7.23395E−02 | 1.99414E−02 |
| plane | | | | |

TABLE 2B

| | D | E | F |
|---|---|---|---|
| 2nd plane | 1.74513E−01 | −5.19513E−01 | 0.00000E+00 |
| 3rd plane | 8.87046E−03 | −3.48271E−02 | 0.00000E+00 |
| 4th plane | −5.01234E−02 | −3.81588E−01 | 3.68320E−01 |
| 5th plane | −2.37026E−01 | 4.12749E−02 | 3.99705E−03 |
| 6th plane | −2.66875E−02 | 8.13352E−03 | −1.08126E−03 |
| 7th plane | −6.26436E−03 | 1.38538E−03 | −1.72735E−04 |

### SECOND EMBODIMENT

The following table 3 represents numerical examples according to a second embodiment of the present invention.

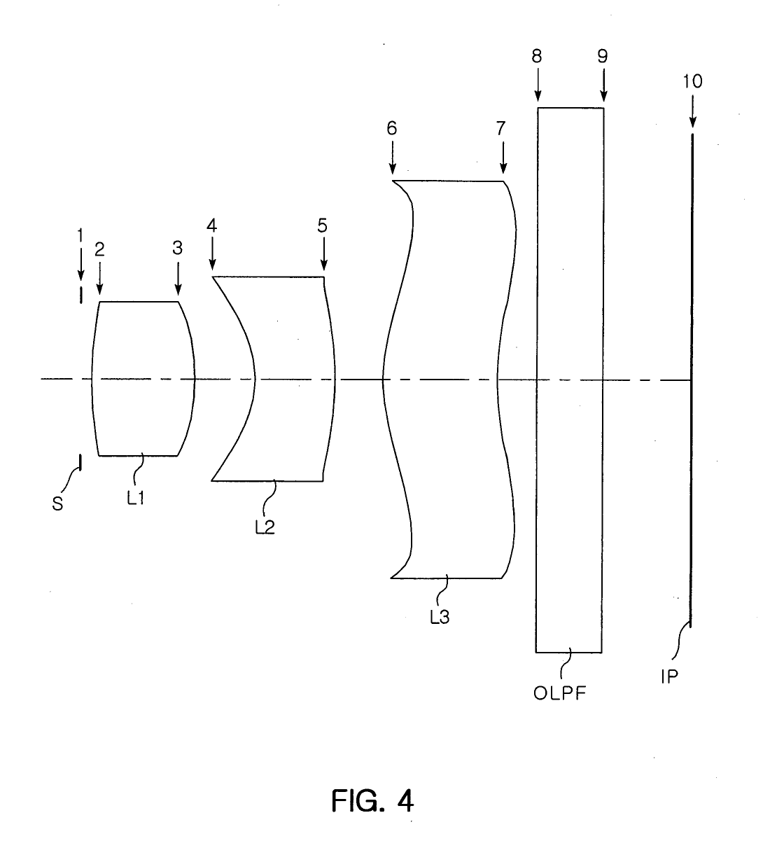

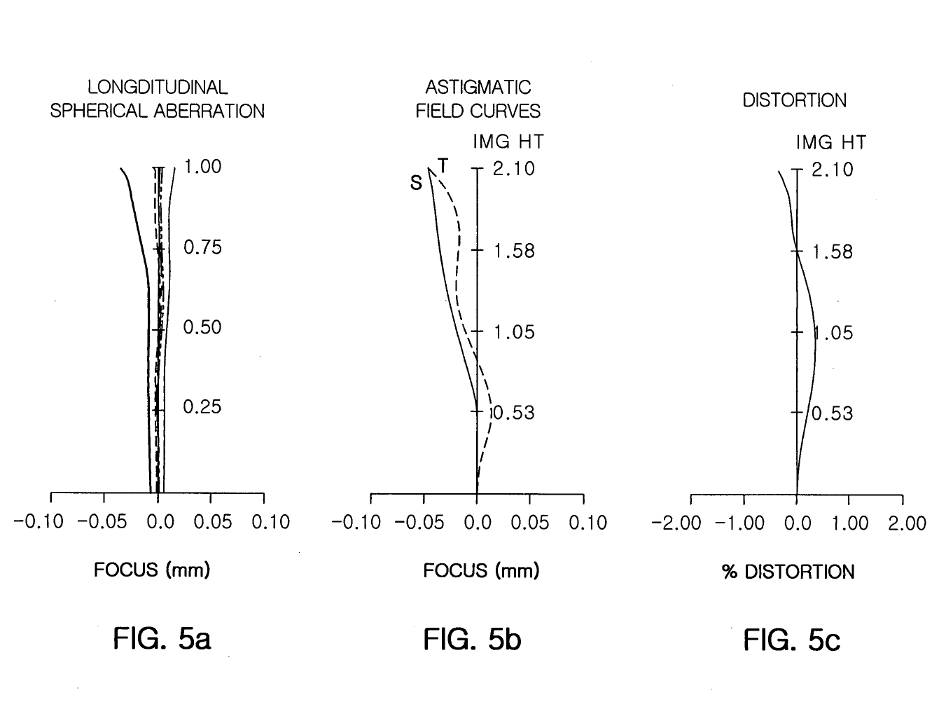

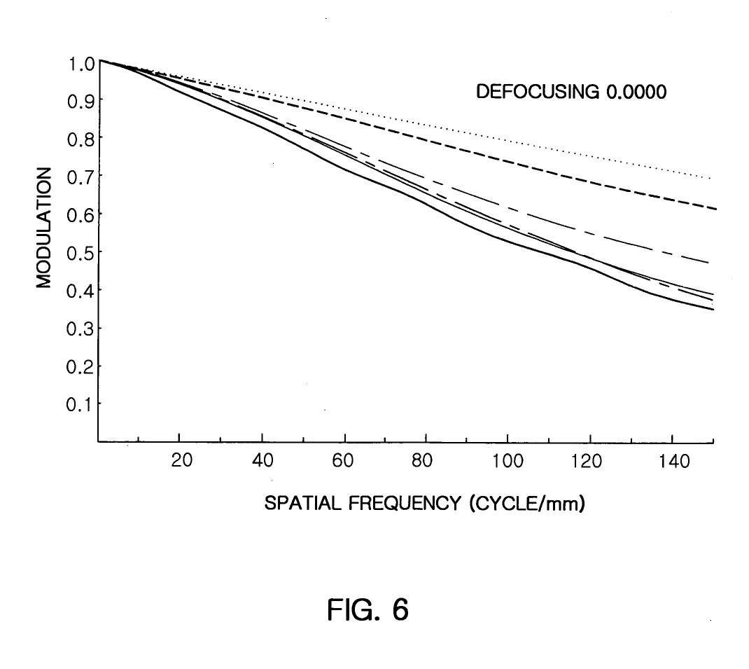

FIG. 4 is a view illustrating a lens construction of an optical system of a high resolution using plastic lenses according to the second embodiment of the present invention, FIGS. 5A through 5C are graphs explaining aberrations of the optical system shown in table 3 and FIG. 4, and FIG. 6 is a graph illustrating MTF characteristics of the second embodiment.

In the second embodiment, an F number (FNo.) is 2.8, an angle of view 62°, a TL is 5.15 mm, an entire focal length f is 3.8 mm, focal lengths f1, f2, and f3 of the first, the second, and the third lenses are 2.3 mm, −2.3 mm, 4.8 mm, respectively. The above lens system is appropriate for a ¼ inch sensor of two-million pixel class.

TABLE 3

| | Radius of | Plane | | Abbe | |
|---|---|---|---|---|---|
| Plane | curvature | interval | Refractive | number | |
| No. | (R) | (t) | index (N_{d}) | (v_{d}) | Remark |
| 1 | ∞ | 0.100000 | | | Aperture |
| | | | | | stop |
| *2 | 2.666805 | 0.870000 | 1.531 | 55.87 | 1st lens |
| *3 | −1.933730 | 0.507640 | | | |
| *4 | −0.938412 | 0.670000 | 1.613 | 26.65 | 2nd lens |
| *5 | −3.609912 | 0.410000 | | | |
| *6 | 1.410005 | 0.970000 | 1.531 | 55.87 | 3rd lens |
| *7 | 2.371143 | 0.330570 | | | |
| 8 | ∞ | 0.550000 | 1.519 | 64.2 | Optical |
| 9 | ∞ | 0.744517 | | | filter |
| 10 | ∞ | 0.000000 | | | Image |
| | | | | | plane |

In table 3, * represents an aspherical surface. In case of the second embodiment, a second plane (object side of the first lens), a third plane (image side of the first lens), a fourth plane (object side of the second lens), a fifth plane (image side of the second lens), and sixth plane (object side of the third lens), and a seventh plane (image side of the third lens) are aspherical.

Aspherical coefficients of the second embodiment by the formula 1 are given in the following tables 4A and 4B.

TABLE 4A

| | K | A | B | C |
|---|---|---|---|---|
| 2^{nd} | 3.74981E−01 | 0.00000E+00 | −8.34823E−02 | −1.00559E−01 |
| plane | | | | |
| 3^{rd} | −5.17135E−01 | 9.39230E−01 | −9.97314E−02 | −1.01824E−01 |
| plane | | | | |
| 4^{th} | −1.06563E+00 | −2.07711E−01 | 5.46416E−02 | 3.79384E−01 |
| plane | | | | |
| 5th | −2.77015E−01 | 1.56194E+00 | −1.72585E−01 | 3.75689E−01 |
| plane | | | | |
| 6th | 7.09220E−01 | −5.61646E+00 | −7.75275E−02 | 4.10092E−02 |
| plane | | | | |
| 7th | 4.21738E−01 | −3.03074E+00 | −7.22217E−02 | 1.01978E−02 |
| plane | | | | |

TABLE 4B

| | D | E | F |
|---|---|---|---|
| 2^{nd} plane | 9.08188E−02 | −3.52284E−01 | 0.00000E+00 |
| 3^{rd} plane | −1.52933E−01 | 1.37170E−01 | 0.00000E+00 |
| 4^{th} plane | −3.16572E−02 | −2.83634E−01 | 2.49969E−01 |
| 5^{th} plane | −2.14659E−01 | 6.34590E−02 | −8.35710E−03 |
| 6^{th} plane | −2.00782E−02 | 7.08146E−03 | −1.44373E−03 |
| 7^{th} plane | −5.27573E−04 | −3.83760E−05 | −7.42094E−05 |

### THIRD EMBODIMENT

The following table 5 represents numerical examples according to a third embodiment of the present invention.

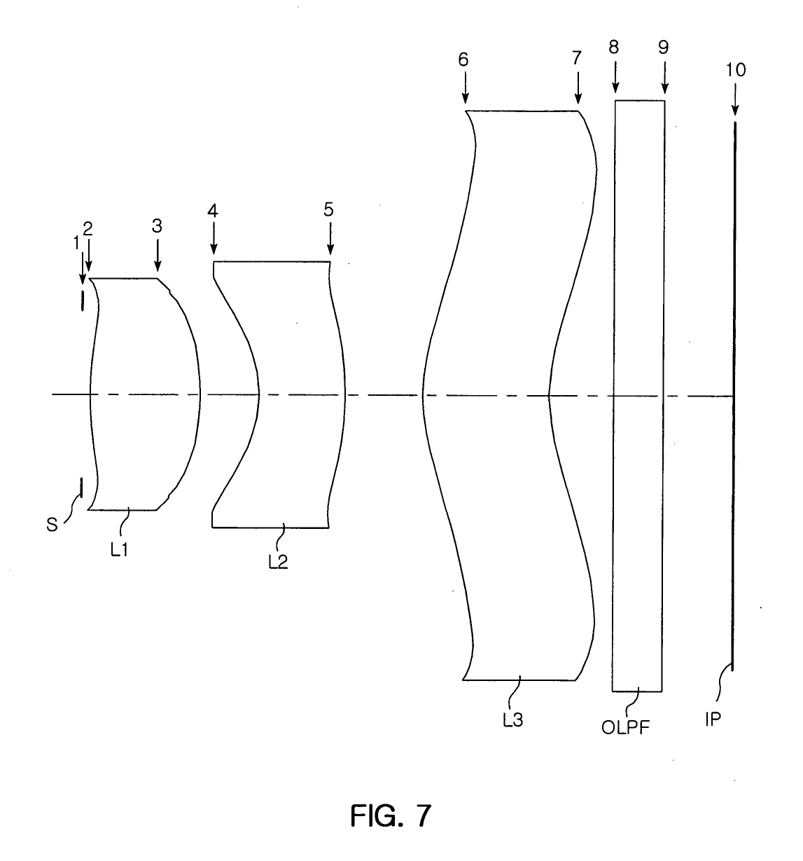

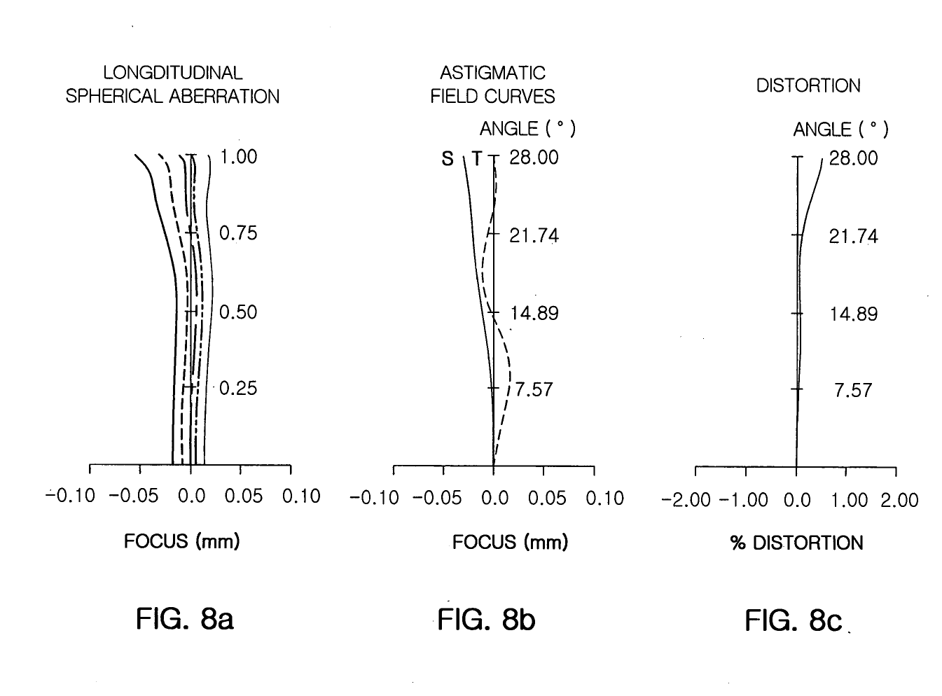

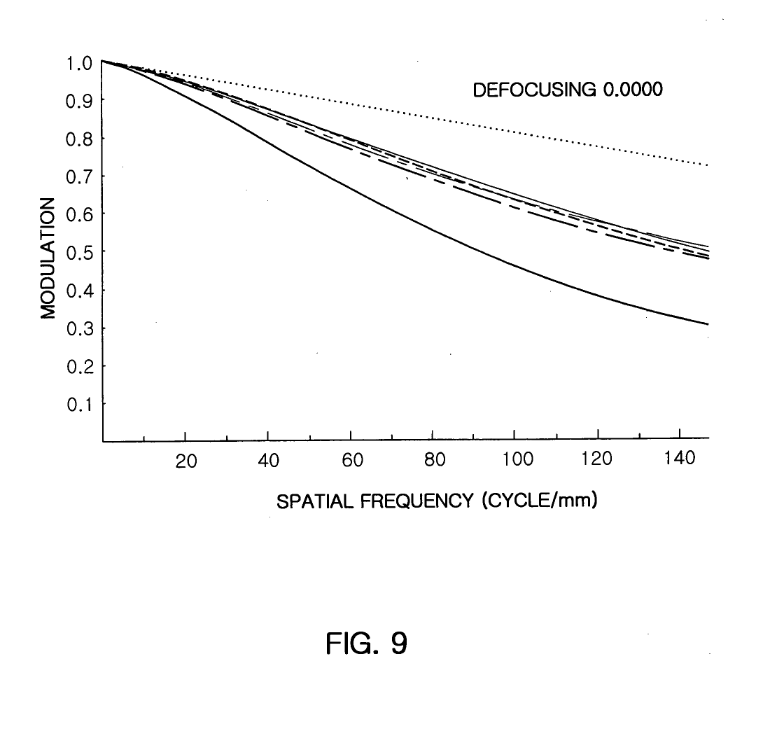

FIG. 7 is a view illustrating a lens construction of an optical system of a high resolution using plastic lenses according to the third embodiment of the present invention, FIGS. 8A through 8C are graphs explaining aberrations of the optical system shown in table 5 and FIG. 7, and FIG. 9 is a graph illustrating MTF characteristics of the third embodiment.

In the third embodiment, an F number (FNo.) is 2.8, an angle of view 60°, a TL is 6.1 mm, an entire focal length f is 4.7 mm, focal lengths f1, f2, and f3 of the first, the second, and the third lenses are 3.3 mm, −4.5 mm, 8.8 mm, respectively. The above lens system is appropriate for a ⅓ inch sensor of two-million pixel class.

TABLE 5

| | Radius of | Plane | | Abbe | |
|---|---|---|---|---|---|
| Plane | curvature | interval | Refractive | number | |
| No. | (R) | (t) | index (N_{d}) | (v_{d}) | Remark |
| 1 | ∞ | 0.100000 | | | Aperture |
| | | | | | stop |
| *2 | 2.70808 | 0.850000 | 1.531 | 55.87 | 1st lens |
| *3 | −4.64176 | 0.740000 | | | |
| *4 | −1.13322 | 0.560000 | 1.613 | 26.65 | 2nd lens |
| *5 | −2.29809 | 0.800000 | | | |
| *6 | 1.67418 | 1.010000 | 1.531 | 55.87 | 3rd lens |
| *7 | 2.05961 | 0.479938 | | | |
| 8 | ∞ | 0.550000 | 1.519 | 64.2 | Optical |
| 9 | ∞ | 1.010062 | | | filter |
| 10 | ∞ | 0.000000 | | | Image |
| | | | | | plane |

In table 5, * represents an aspherical surface. In case of the third embodiment, a second plane (object side of the first lens), a third plane (image side of the first lens), a fourth plane (object side of the second lens), a fifth plane (image side of the second lens), and sixth plane (object side of the third lens), and a seventh plane (image side of the third lens) are aspherical.

Aspherical coefficients of the third embodiment by the formula 1 are given in the following tables 6A and 6B.

TABLE 6A

| | K | A | B | C |
|---|---|---|---|---|
| 2^{nd} | 3.69265E−01 | 0.00000E+00 | −3.32618E−02 | −4.11005E−02 |
| plane | | | | |
| 3^{rd} | −2.15436E−01 | 1.38671E+01 | −6.97704E−02 | −1.61706E−02 |
| plane | | | | |
| 4^{th} | −8.82441E−01 | −3.54042E−01 | −5.32870E−02 | 2.01787E−01 |
| plane | | | | |
| 5^{th} | −4.35144E−01 | −1.41363E−01 | −9.06073E−02 | 1.47609E−01 |
| plane | | | | |
| 6^{th} | 5.97307E−01 | −4.37020E+00 | −4.35302E−02 | 1.47621E−02 |
| plane | | | | |
| 7^{th} | 4.85529E−01 | −3.85558E+00 | −4.52623E−02 | 1.08727E−02 |
| plane | | | | |

TABLE 6B

| | D | E | F |
|---|---|---|---|
| 2nd | 2.26987E−02 | −4.11306E−02 | 0.00000E+00 |
| plane | | | |
| 3rd | 3.45963E−03 | −1.79847E−03 | 0.00000E+00 |
| plane | | | |
| 4th | 1.62034E−04 | −5.34532E−02 | 2.13698E−02 |
| plane | | | |
| 5th | −2.68155E−02 | −1.98525E−03 | 6.51040E−04 |
| plane | | | |
| 6th | −2.75307E−03 | 2.31915E−04 | −6.82584E−06 |
| plane | | | |
| 7th | −1.64742E−03 | 1.10833E−04 | −3.23087E−06 |
| plane | | | |

The above-described embodiments show that the present invention has advantages of obtaining an optical system having excellent aberration characteristics as illustrated in FIGS. 2, 5, and 8 and realizing an optical system of a high resolution having excellent MTF characteristics as illustrated in FIGS. 3, 6, and 9.

As described above, the present invention has an effect of realizing a compact optical system having small lens combinations with a high resolution using only three plastic lenses.

Further, the present invention can not only achieve a light weight but also can be manufactured through a mass-production process thanks to its easy manufacturing features, realizing an optical system with low manufacturing costs.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An optical system for a high resolution using plastic lenses, comprising, sequentially from an object side:
an aperture stop arranged most closely to the object side;
a first plastic lens having plus refractive power;
a second plastic lens having minus refractive power; and
a third plastic lens having plus refractive power, a refractive index of the second lens satisfying the following equation 1, and an abbe number of the second lens satisfying the following equation 2:
1.59<n2<1.65 Equation 1,
20<v2<30 Equation 2,
where, n2: refractive index of second lens v2: abbe number of second lens.

2. The system of claim 1, wherein refractive indexes of the first and the third lenses and abbe numbers of the first and the third lenses additionally satisfy the following equations 3 through 6:
1.45<n1<1.59 Equation 3,
50<v1<60 Equation 4,
1.45<n3<1.59 Equation 5,
50<v3<60 Equation 6,
where, n1: refractive index of first lens
v1: abbe number of first lens
n3: refractive index of third lens
v3: abbe number of third lens.

3. The system of claim 2, wherein a power of the first lens additionally satisfies the following equation 7 and a measure in an optical axis direction of an entire lens system satisfies the following equation 8:
0.5<f1/f<1.0 Equation 7,
TL/f<2.0 Equation 8,
where, f1: focal length of first lens
f: focal length of entire optical system
TL: distance from aperture stop to image plane

4. The system of claim 3, wherein powers of the first and the second lenses additionally satisfy the following equation 9:
0.5<|f2|/f1<2.0 Equation 9
where, f2: focal length of second lens (f2<0)

5. The system of claim 1, wherein at least one refraction plane among refraction planes of the first, the second, and the third lenses is an aspherical plane.
